(19) United States
(12) Patent Application Publication
(10) Pub. No.: US 2009/0036064 A1
(43) Pub. Date: Feb. 5, 2009

(54) DIGITAL INTEGRATED TRANSMITTER BASED ON FOUR-PATH PHASE MODULATION

(76) Inventors: Ashoke Ravi, Hillsboro, OR (US); Ofir Degani, Haifa (IL); Hasnain Lakdawala, Beaverton, OR (US)

Correspondence Address: COOL PATENT, P.C.;c/o INTELLEVATE, P.O. BOX 52050, MINNEAPOLIS, MN, 55402, US

(21) Appl. No.: 11/831,017

(22) Filed: Jul. 31, 2007

(51) Int. Cl. H04B 1/40; H04L 27/20

(52) U.S. Cl. 455/76; 332/103

(57) ABSTRACT

Briefly, in accordance with one or more embodiments, a transmitter comprises four phase modulators to provide four path phase modulation. The phase modulators modulate local oscillator signals with control signals derived from quadrature baseband data to be transmitted to result in four phase modulated signals. The four phase modulated signals may be combined to provide a pulse position and pulse width modulated signal that may have a constant, or nearly constant, amplitude. The frequency spectrum of the control signals have narrower bandwidths and greater out of band attenuation resulting in higher suppression of out of channel and out of band noise.

### BACKGROUND

Orthogonal frequency division multiplexing (OFDM) has become the modulation of choice for higher data rate wireless communication links for personal area networks (PAN), local area networks (LAN) and metropolitan area networks (MAN) networks. OFDM waveforms have both amplitude and phase information requiring linear amplifiers generally having lower efficiency in the transmitter power amplifier (PA). The significant peak to average power ratios, typically 10 dB to 15 dB, further reduces the average efficiency of such OFDM transmitters. Power control on mobile units may further result in an average transmit power that is typically 30 dB to 50 dB lower than the peak power, and a corresponding reduction in efficiency. In mobile and handheld applications, such lower power efficiency in transmit mode may severely affect reliability, for example due to thermal issues, as well as limiting battery life of the hand held device. Switching power amplifiers, commonly utilized with pure frequency/phase modulation schemes, are capable of achieving a higher efficiency, however the application of switching power amplifiers to OFDM systems is not straightforward.

Furthermore, conventional radio transmitters comprise analog circuits which are sensitive to process, voltage and/or temperature, typically utilize inductors that occupy a larger die area, and/or that are not compatible with scaled lower voltage complementary metal-oxide semiconductor (CMOS) processes such as headroom/linearity, gain and/or matching constraints. The increasing speed of the lower voltage transistor can be exploited to replace lower speed, higher resolution analog circuits with higher speed, lower resolution circuits.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a wireless network capable of utilizing a digital integrated transmitter based on four-path phase modulation in accordance with one or more embodiments;

FIG. 2 is a diagram of a digital integrated transmitter based on four-path phase modulation in accordance with one or more embodiments;

FIG. 3 is a plot of the spectrum of four-path modulation as utilized a digital integrated transmitter based on four-path phase modulation as shown in FIG. 2 in accordance with one or more embodiments;

FIG. 4 is a flow diagram of a method for decomposing the modulation of a signal to be transmitted into four paths with lower bandwidth in accordance with one or more embodiments;

FIG. 5 is a block diagram of an information handling system capable of utilizing a digital integrated transmitter based on four-path phase modulation in accordance with one or more embodiments; and

FIG. 6 is a block diagram of a wireless local area or cellular network communication system showing one or more network devices capable of utilizing a digital integrated transmitter based on four-path phase modulation in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

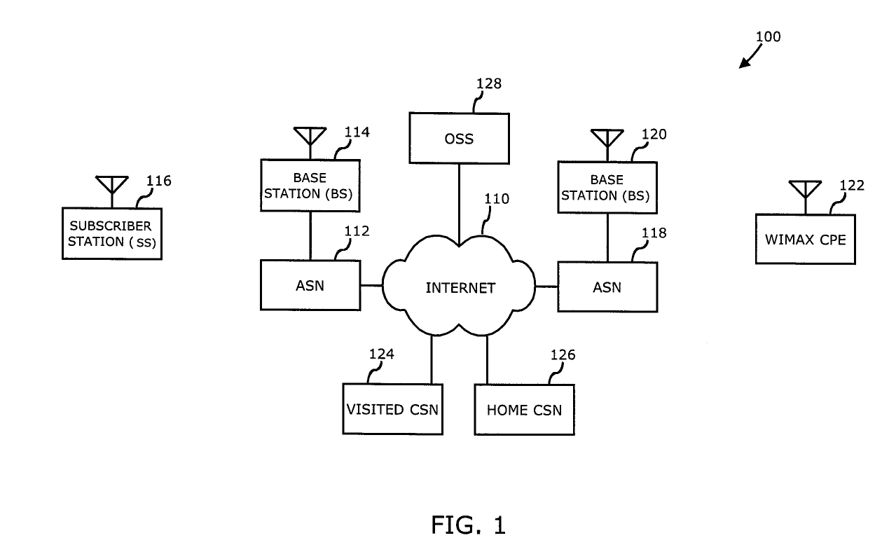

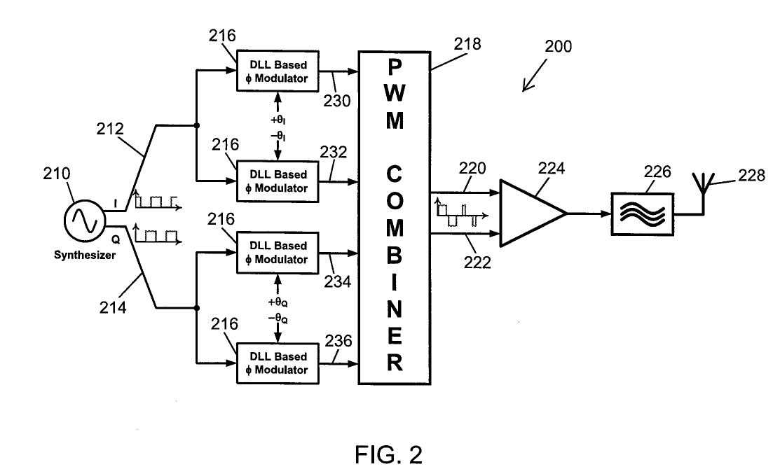

Referring now to FIG. 1, a block diagram of a wireless network capable of utilizing a digital integrated transmitter based on four-path phase modulation in accordance with one or more embodiments will be discussed. In one or more embodiments, any one or more of base station 114, subscriber station 116, base station 122, and/or WiMAX customer premises equipment (CPE) 122 may utilize the transmitter 200 of FIG. 2, below, comprising a digital integrated transmitter based on four-path phase modulation, although the scope of the claimed subject matter is not limited in this respect. As shown in FIG. 1, network 100 may be an internet protocol (IP) type network comprising an internet 110 type network or the like that is capable of supporting mobile wireless access and/or fixed wireless access to internet 110. In one or more embodiments, network 100 may be in compliance with a Worldwide Interoperability for Microwave Access (WiMAX) standard or future generations of WiMAX, and in one particular embodiment may be in compliance with an Institute for Electrical and Electronics Engineers 802.16e standard (IEEE 802.16e). In one or more alternative embodiments network 100 may be in compliance with a Third Generation Partnership Project Long Term Evolution (3GPP LTE) or a 3GPP2 Air Interface Evolution (3GPP2 AIE) standard. In general, network 100 may comprise any type of orthogonal frequency division multiple access (OFDMA) based wireless network, although the scope of the claimed subject matter is not limited in these respects. As an example of mobile wireless access, access service network (ASN) 112 is capable of coupling with base station (BS) 114 to provide wireless communication between subscriber station (SS) 116 and internet 110. Subscriber station 116 may comprise a mobile type device or information handling system capable of wirelessly communicating via network 100, for example a notebook type computer, a cellular telephone, a personal digital assistant, or the like. ASN 112 may implement profiles that are capable of defining the mapping of network functions to one or more physical entities on network 100. Base station 114 may comprise radio equipment to provide radio-frequency (RF) communication with subscriber station 116, and may comprise, for example, the physical layer (PHY) and media access control (MAC) layer equipment in compliance with an IEEE 802.16e type standard. Base station 114 may further comprise an IP backplane to couple to internet 110 via ASN 112, although the scope of the claimed subject matter is not limited in these respects.

Network 100 may further comprise a visited connectivity service network (CSN) 124 capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VOIP) gateways, and/or internet protocol (IP) type server functions, or the like. However, these are merely example of the types of functions that are capable of being provided by visited CSN or home CSN 126, and the scope of the claimed subject matter is not limited in these respects. Visited CSN 124 may be referred to as a visited CSN in the case for example where visited CSN 124 is not part of the regular service provider of subscriber station 116, for example where subscriber station 116 is roaming away from its home CSN such as home CSN 126, or for example where network 100 is part of the regular service provider of subscriber station but where network 100 may be in another location or state that is not the main or home location of subscriber station 116. In a fixed wireless arrangement, WiMAX type customer premises equipment (CPE) 122 may be located in a home or business to provide home or business customer broadband access to internet 110 via base station 120, ASN 118, and home CSN 126 in a manner similar to access by subscriber station 116 via base station 114, ASN 112, and visited CSN 124, a difference being that WiMAX CPE 122 is generally disposed in a stationary location, although it may be moved to different locations as needed, whereas subscriber station may be utilized at one or more locations if subscriber station 116 is within range of base station 114 for example. In accordance with one or more embodiments, operation support system (OSS) 128 may be part of network 100 to provide management functions for network 100 and to provide interfaces between functional entities of network 100. Network 100 of FIG. 1 is merely one type of wireless network showing a certain number of the components of network 100 that are capable of utilizing a digital integrated transmitter based on four-path phase modulation as shown in FIG. 2, below, and the scope of the claimed subject matter is not limited in these respects.

Although network 100 as shown in FIG. 1 is a WiMAX network as an example, it should be noted that transmitter 200 of FIG. 2, below may be utilized in other types of wireless networks and/or applications utilizing wideband orthogonal frequency division multiplexing (OFDM) modulation. For example, in one or more embodiments, network 100 alternately may comprise a network in compliance with an Institute of Electrical and Electronics Engineers (IEEE) standard such as an IEEE 802.11 a/b/g/n standard, an IEEE 802.16 d/e standard, an IEEE 802.20 standard, an IEEE 802.15 standard, an Ultra-Wide Band (UWB) standard, a Third Generation Partnership Project Long Term Evolution (3GPP-LTE) standard, an Enhanced Data Rates for Global System for Mobile Communications (GSM) Evolution (EDGE) standard, a Wideband Code Division Multiple Access (WCDMA) standard, a Digital Video Broadcasting (DVB) standard, or the like, and the scope of the claimed subject matter is not limited in this respect. Furthermore, although examples herein are directed to OFDM modulation, the scope of the claimed subject matter may apply to any type of modulation, including but not limited to continuous wave (CW) modulation, amplitude-shift keying (ASK) modulation, phase-shift keying (PSK) modulation, frequency-shift keying (FSK) modulation, quadrature amplitude modulation (QAM), continuous phase modulation (CPM), trellis code modulation (TCM), and so on.

Referring now to FIG. 2, a diagram of a digital integrated transmitter based on four-path phase modulation in accordance with one or more embodiments will be discussed. In one or more embodiments, transmitter 200 comprises frequency synthesizer 210 that produces quadrature square wave local oscillator (LO) signals at lines 212 and 214 that are utilized to drive four phase modulators 216. In one or more alternative embodiments, two phase modulators 216 may be utilized to implement the modulation scheme as shown in FIG. 2, for example where one phase modulator is utilized for signal line 212 and second phase modulator is utilized for signal line 214, although the scope of the claimed subject matter is not limited in this respect. In one or more embodiments, one or more of phase modulators 216 comprise delay-locked loop (DLL) modulators, although the scope of the claimed subject matter is not limited in this respect. The phase modulation is introduced by a pair of time varying independent control signals, θ_{I} and θ_{Q} derived from the I-Q baseband data using the following equations:

$$\begin{matrix}Desired RF \\ Signal\end{matrix} \text{:} {y}_{o} ( t ) = {{↔}^{I ( t ) \cdot cos ( ω t )}}_{Pure AM} + {{↔}^{Q ( t ) \cdot sin ( ω t ) }}_{Pure AM} \\ ↓ ↓ \\ {θ}_{I} ( t ) {θ}_{Q} ( t )$$

$$I ( t ) \cdot cos ( ω t ) = A cos ( ω t + {θ}_{I} ( t ) ) + A cos ( ω t - {θ}_{I} ( t ) ) \\ Q ( t ) \cdot sin ( ω t ) = A sin ( ω t + {θ}_{Q} ( t ) ) + A sin ( ω t - {θ}_{Q} ( t ) ) \\ {θ}_{I} ( t ) = {cos}^{- 1} ( \frac{I ( t )}{A} ) {θ}_{Q} ( t ) = {cos}^{- 1} ( \frac{Q ( t )}{A} )$$

In the above equations, the desired RF signal is converted from an amplitude modulated (AM) signal having two quadrature components, I and Q, into four quadrature components +θ_{I}, −θ_{I}, +θ_{Q}, and −θ_{Q} which are used to modulate the LO signals provided to the inputs of phase modulators 216 as the control signals. The outputs of phase modulators 216 produced by the four paths in such an arrangement at outputs 230, 232, 234, and 236 are:

p₁(t)=A cos(ωt+θ_{I})

p₂(t)=A cos(ωt−θ_{I})

p₃(t)=A sin(ωt+θ_{Q})

p₄(t)=A sin(ωt−θ_{Q})

The resulting four phase modulated signals, ρ₁(t), ρ₂(t), ρ₃(t), and ρ₄(t), in the above equations represent the respective outputs 230, 232, 234, and 236 of phase modulators 216. It should be noted that although transmitter 200 of FIG. 1 shows a digital integrated transmitter based on four-path phase modulation, other numbers of phase modulation may likewise be utilized, for example eight-path phase modulation, and so on, and the scope of the claimed subject matter is not limited in this respect.

In a general embodiment of transmitter 200, the four phase modulated signals provided by phase modulators 216 at outputs 230, 232, 234, and 236 are combined via combiner 218 to produce a pulse position and width modulated output at differential outputs 220 and 222 of combiner 218. In one or more embodiments, such an output of combiner 218 may have a constant, or nearly constant amplitude, and the information to be transmitted is related to the position of a pulse and/or the width of a pulse. This differential signal at differential outputs 220 and 222 is utilized to drive one or more switching power amplifiers (PA) 224. The output of the one or more power amplifiers 224 is provided to an impedance matching network 226 and antenna 228, which may comprise for example an omnidirectional antenna, for transmission as a radio-frequency (RF) signal. Any mismatches between the paths at outputs 220 and 222 may be calibrated digitally via correction to θ_{I} and/or θ_{Q}.

In one or more embodiments, combiner 218 may comprise a pulse-width modulation (PWM) combiner that may be implemented using one or more logic gates, for example exclusive OR (XOR) gates, and one or more digital-to-analog converters (DAC). In one or more embodiments, power amplifier 224 may be implemented using one to four parallel switches to provide a switched power amplifier. In one or more embodiments, one or more of phase modulators 216 may be implemented using any of the following circuits: open loop delay lines, closed loop delay lines and delay-locked loops (DLL), a DLL controlled by a DAC, delay lines with sigma-delta phase selection in open loop or embedded in DLLs, integer-n phase-locked loop (PLL), fractional-n PLLs, offset loop PLLs, reference modulated PLLs, and/or direct digital synthesis. However, these are merely example implementations of phase modulators 216, and the scope of the claimed subject matter is not limited in these respects. In one or more embodiments, transmitter 200 is capable of being reconfigured for different standards, for example as a multi-mode radio achieved via switching in and out logic gates and/or varying the clock frequency, although the scope of the claimed subject matter is not limited in this respect.

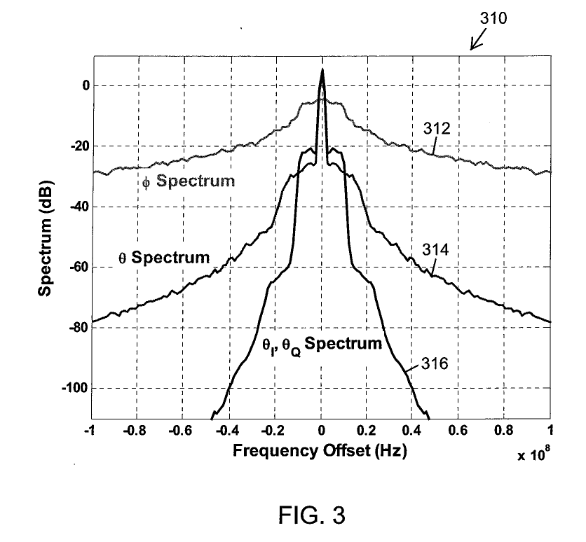

Referring now to FIG. 3, a plot of the spectrum of four-path modulation as utilized a digital integrated transmitter based on four-path phase modulation as shown in FIG. 2 in accordance with one or more embodiments will be discussed. As shown in plot 300, spectrum output is plotted on the vertical axis in decibels (dB) versus frequency offset in Hertz (Hz). The resulting spectrum for conventional outphasing decomposition are plotted showing the □ spectrum at plot 310 and the θ spectrum at plot 312. The resulting spectrum for the four path decomposition implemented by transmitter 200 of FIG. 2 is plotted showing the θ_{I}, θ_{Q} spectrum at plot 314. Conventional schemes to enable the use of switching power amplifiers rely on polar envelope elimination and restoration (EER) or outphasing decomposition of the desired radio-frequency (RF) signal. As shown in FIG. 2 at plots 310 and 312, such decompositions, θ, □ produce signals with very wide bandwidths, typically greater than three to five times the modulation bandwidth. In order to reconstruct the OFDM signal with good error vector magnitude (EVM), the transmitter circuits for the conventional schemes are required to support wider bandwidths, which in turn limits the amount of achievable out-of-channel and out-of-band filtering. Using the architecture of transmitter 200 as shown in FIG. 2, the decomposed signals, the θ_{I} and θ_{Q}, have bandwidths comparable to the desired signal as shown by plot 314 in FIG. 3. In such an arrangement, transmitter 200 is capable of achieving better suppression of out-of channel and out-of-band noise, although the scope of the claimed subject matter is not limited in these respects.

FIG. 3 illustrates that transmitter 200 of FIG. 2 may implement a constant amplitude phase modulation based transmitter for wide bandwidth signals via four paths at a lower bandwidth on the four paths without requiring the use of a single higher bandwidth phase modulation path. In such an arrangement of transmitter 200, it is possible to utilize relaxed filtering requirements to filter out of band signals since, as shown in FIG. 3, the out of band spectrum shown at plot 314 for transmitter 200 is lower than with single path phase modulation. Such an arrangement may facilitate lower out of band power transmission requirements set by regulatory bodies, although the scope of the claimed subject matter is not limited in this respect.

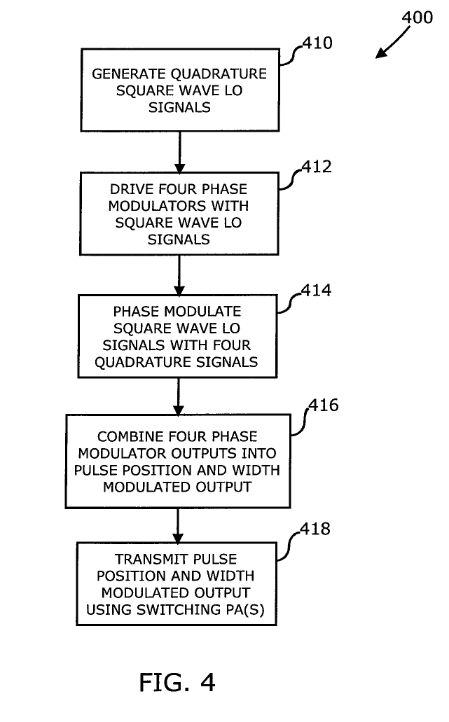

Referring now to FIG. 4, a flow diagram of a method for decomposing the modulation of a signal to be transmitted into four paths with lower bandwidth in accordance with one or more embodiments will be discussed. Although FIG. 4 shows one particular order of the blocks of method 400, method 400 is not limited to any particular order of the blocks, and may further include more or fewer blocks than shown in FIG. 4. Furthermore, although method 400 is directed to four path phase modulation for a digital transmitter such as transmitter 200 of FIG. 2, other numbers of paths for phase modulation may be implemented, and the scope of the claimed subject matter is not limited in these respects.

In one or more embodiments of method 400, quadrature square wave local oscillator (LO) signals may be generated at block 410, for example via synthesizer 210, and separated into four paths, two in-phase (I) paths and two quadrature (Q) paths as shown for example in FIG. 2. The square wave LO signals may drive four phase modulators 216 at block 412, and the square wave LO signals may be phase modulated with the four quadrature components +θ_{I}, −θ_{I}, +θ_{Q}, and −θ_{Q} applied to phase modulators 216. The four outputs 230, 232, 234, and 236 of phase modulators 216 may be combined at block 416 via combiner 218 to result in a pulse position and pulse width modulated output at differential outputs 220 and 222, which may have a constant amplitude in one or more embodiments. The pulse position and pulse width output may then be transmitted at block 418 as an OFDM signal using one or more switching power amplifiers 224.

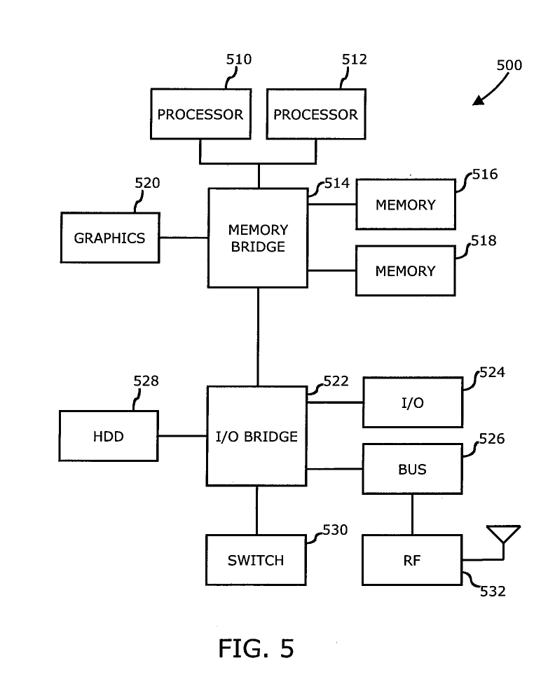

Referring now to FIG. 5, a block diagram of an information handling system capable of utilizing a digital integrated transmitter based on four-path phase modulation in accordance with one or more embodiments. Information handling system 500 of FIG. 5 may tangibly embody one or more of any of the network elements of network 100 as shown in and described with respect to FIG. 1. For example, information handling system 500 may represent the hardware of base station 114 and/or subscriber station 116, with greater or fewer components depending on the hardware specifications of the particular device or network element. Although information handling system 500 represents one example of several types of computing platforms, information handling system 500 may include more or fewer elements and/or different arrangements of elements than shown in FIG. 5, and the scope of the claimed subject matter is not limited in these respects.

Information handling system 500 may comprise one or more processors such as processor 510 and/or processor 512, which may comprise one or more processing cores. One or more of processor 510 and/or processor 512 may couple to one or more memories 516 and/or 518 via memory bridge 514, which may be disposed external to processors 510 and/or 512, or alternatively at least partially disposed within one or more of processors 510 and/or 512. Memory 516 and/or memory 518 may comprise various types of semiconductor based memory, for example volatile type memory and/or non-volatile type memory. Memory bridge 514 may couple to a graphics system 520 to drive a display device (not shown) coupled to information handling system 500.

Information handling system 500 may further comprise input/output (I/O) bridge 522 to couple to various types of I/O systems. I/O system 524 may comprise, for example, a universal serial bus (USB) type system, an IEEE 1394 type system, or the like, to couple one or more peripheral devices to information handling system 500. Bus system 526 may comprise one or more bus systems such as a peripheral component interconnect (PCI) express type bus or the like, to connect one or more peripheral devices to information handling system 500. A hard disk drive (HDD) controller system 528 may couple one or more hard disk drives or the like to information handling system, for example Serial ATA type drives or the like, or alternatively a semiconductor based drive comprising flash memory, phase change, and/or chalcogenide type memory or the like. Switch 530 may be utilized to couple one or more switched devices to I/O bridge 522, for example Gigabit Ethernet type devices or the like. Furthermore, as shown in FIG. 5, information handling system 500 may include a radio-frequency (RF) block 532 comprising RF circuits and devices for wireless communication with other wireless communication devices and/or via wireless networks such as network 100 of FIG. 1, for example where information handling system 500 embodies base station 114 and/or subscriber station 116, although the scope of the claimed subject matter is not limited in this respect. In one or more embodiments, RF block 532 may comprise transmitter 200 of FIG. 2, at least in part. Furthermore, at least some portion of transmitter 200 may be implemented by processor 510, for example the digital functions of transmitter 200 which may include processing of the baseband and/or quadrature signals, although the scope of the claimed subject matter is not limited in this respect.

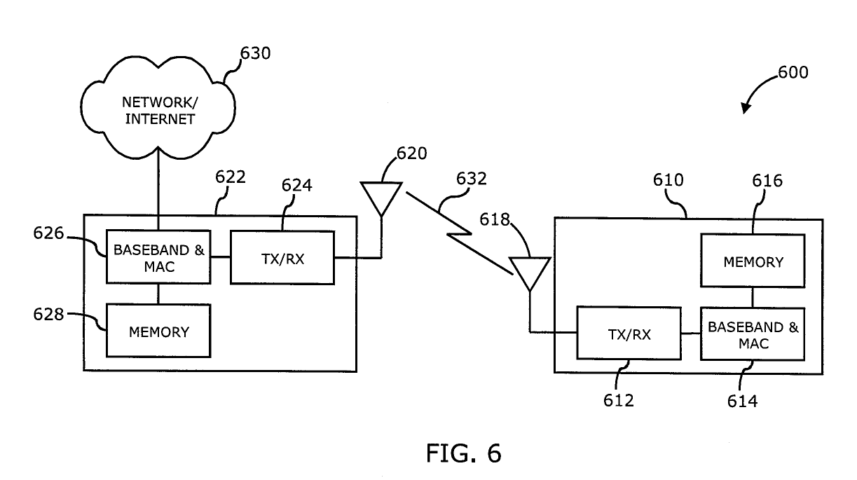

Referring now to FIG. 6, a block diagram of a wireless local area or cellular network communication system showing one or more network devices in accordance with one or more embodiments will be discussed. In the communication system 600 shown in FIG. 6, a mobile unit 610 may include a wireless transceiver 612 to couple to an antenna 618 and to a processor 614 to provide baseband and media access control (MAC) processing functions. In one or more embodiments, mobile unit 610 may be a cellular telephone or an information handling system such as a mobile personal computer or a personal digital assistant or the like that incorporates a cellular telephone communication module, although the scope of the claimed subject matter is not limited in this respect. Processor 614 in one embodiment may comprise a single processor, or alternatively may comprise a baseband processor and an applications processor, although the scope of the claimed subject matter is not limited in this respect. Processor 614 may couple to a memory 616 which may include volatile memory such as dynamic random-access memory (DRAM), non-volatile memory such as flash memory, or alternatively may include other types of storage such as a hard disk drive, although the scope of the claimed subject matter is not limited in this respect. Some portion or all of memory 616 may be included on the same integrated circuit as processor 614, or alternatively some portion or all of memory 616 may be disposed on an integrated circuit or other medium, for example a hard disk drive, that is external to the integrated circuit of processor 614, although the scope of the claimed subject matter is not limited in this respect.

Mobile unit 610 may communicate with access point 622 via wireless communication link 632, where access point 622 may include at least one antenna 620, transceiver 624, processor 626, and memory 628. In one embodiment, access point 622 may be a base station of a cellular telephone network, and in an alternative embodiment, access point 622 may be a an access point or wireless router of a wireless local or personal area network, although the scope of the claimed subject matter is not limited in this respect. In an alternative embodiment, access point 622 and optionally mobile unit 610 may include two or more antennas, for example to provide a spatial division multiple access (SDMA) system or a multiple input, multiple output (MIMO) system, although the scope of the claimed subject matter is not limited in this respect. Access point 622 may couple with network 630 so that mobile unit 610 may communicate with network 630, including devices coupled to network 630, by communicating with access point 622 via wireless communication link 632. Network 630 may include a public network such as a telephone network or the Internet, or alternatively network 630 may include a private network such as an intranet, or a combination of a public and a private network, although the scope of the claimed subject matter is not limited in this respect. Communication between mobile unit 610 and access point 622 may be implemented via a wireless local area network (WLAN), for example a network compliant with a an Institute of Electrical and Electronics Engineers (IEEE) standard such as IEEE 802.11a, IEEE 802.11b, HiperLAN-II, and so on, although the scope of the claimed subject matter is not limited in this respect. In another embodiment, communication between mobile unit 610 and access point 622 may be at least partially implemented via a cellular communication network compliant with a Third Generation Partnership Project (3GPP or 3G) standard, although the scope of the claimed subject matter is not limited in this respect. In one or more embodiments, antenna 618 may be utilized in a wireless sensor network or a mesh network, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to a digital integrated transmitter based on four-path phase modulation and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An apparatus, comprising:
a frequency synthesizer to generate local oscillator signals;
four phase modulators to modulate the local oscillator signals with control signals derived from quadrature baseband data to be transmitted, the four phase modulators providing four phase modulated signals; and
a combiner to combine the four phase modulated signals into a pulse position and pulse width modulated signal to be transmitted.

2. An apparatus as claimed in claim 1, wherein the pulse position and pulse width modulated signal to be transmitted comprises a signal modulated via one or more of the following modulation schemes: orthogonal frequency division multiplexing (OFDM), continuous wave (CW) modulation, amplitude-shift keying (ASK) modulation, phase-shift keying (PSK) modulation, frequency-shift keying (FSK) modulation, quadrature amplitude modulation (QAM), continuous phase modulation (CPM), trellis code modulation (TCM), or combinations thereof.

3. An apparatus as claimed in claim 1, wherein the pulse position and pulse width modulated signal to be transmitted has a constant, or nearly constant, amplitude.

4. An apparatus as claimed in claim 1, wherein at least one or more of the four phase modulators comprises a delay-locked loop, an open loop delay line, a closed loop delay line and a delay-locked loop, a delay-locked loop controlled by a digital-to-analog converter, a delay line with sigma-delta phase selection in open loop, or a delay line with sigma-delta phase selection in open loop embedded in a delay-locked loop, a phase-locked loop, an integer-n phase-locked loop, a fractional-n phase-locked loop, an offset loop phase-locked loop, a reference modulated phase-locked loop, or a direct digital synthesis circuit, or combinations thereof.

5. An apparatus as claimed in claim 1, wherein the four phase modulators operate at a lower bandwidth than phase modulation involving fewer than four modulation paths at a higher bandwidth.

6. An apparatus as claimed in claim 1, wherein a frequency spectrum of one or more of the control signals exhibits greater out of band attenuation than phase modulation involving fewer than four modulation paths.

7. An apparatus as claimed in claim 1, further comprising one or more switching power amplifiers to amplify the pulse position and pulse width modulated signal to be transmitted to a power level suitable for transmission.

8. An apparatus as claimed in claim 1, wherein the pulse position and pulse width modulated signal to be transmitted provided by the combiner comprises a differential signal.

9. An apparatus as claimed in claim 1, wherein the combiner comprises a pulse-width modulation combiner.

10. An apparatus as claimed in claim 1, wherein the combiner comprises one or more logic gates and one or more digital-to-analog converters.

11. A method, comprising:
generating local oscillator signals;
modulating the local oscillator signals with control signals derived from quadrature baseband data to be transmitted to result in four phase modulated signals; and
combining the four phase modulated signals into a pulse position and pulse width modulated signal to be transmitted.

12. A method as claimed in claim 11, wherein the pulse position and pulse width modulated signal to be transmitted comprises a signal modulated via one or more of the following modulation schemes: orthogonal frequency division multiplexing (OFDM), continuous wave (CW) modulation, amplitude-shift keying (ASK) modulation, phase-shift keying (PSK) modulation, frequency-shift keying (FSK) modulation, quadrature amplitude modulation (QAM), continuous phase modulation (CPM), trellis code modulation (TCM), or combinations thereof.

13. A method as claimed in claim 11, wherein the pulse position and pulse width modulated signal to be transmitted has a constant, or nearly constant, amplitude.

14. A method as claimed in claim 11, said modulating occurs at a lower bandwidth than phase modulation involving fewer than four modulation paths at a higher bandwidth.

15. A method as claimed in claim 11, wherein a frequency spectrum of one or more of the control signals exhibits greater out of band attenuation than phase modulation involving fewer than four modulation paths.

16. A method as claimed in claim 11, further comprising amplifying the pulse position and pulse width modulated signal to be transmitted to a power level suitable for transmission.

17. A method as claimed in claim 11, wherein the pulse position and pulse width modulated signal to be transmitted comprises a differential signal.

18. A method as claimed in claim 11, said combining comprising pulse-width modulation.

19. An apparatus, comprising:
a baseband processor;
a transceiver coupled to the baseband processor; and
an omnidirectional antenna coupled to the transceiver;
wherein the transceiver comprises:
a frequency synthesizer to generate local oscillator signals;
four phase modulators to modulate the local oscillator signals with control signals derived from quadrature baseband data to be transmitted, the four phase modulators providing four phase modulated signals; and
a combiner to combine the four phase modulated signals into a pulse position and pulse width modulated signal to be transmitted.

20. An apparatus as claimed in claim 19, wherein the pulse position and pulse width modulated signal to be transmitted comprises a signal modulated via one or more of the following modulation schemes: orthogonal frequency division multiplexing (OFDM), continuous wave (CW) modulation, amplitude-shift keying (ASK) modulation, phase-shift keying (PSK) modulation, frequency-shift keying (FSK) modulation, quadrature amplitude modulation (QAM), continuous phase modulation (CPM), trellis code modulation (TCM), or combinations thereof.

21. An apparatus as claimed in claim 19, wherein the pulse position and pulse width modulated signal to be transmitted has a constant, or nearly constant, amplitude.

22. An apparatus as claimed in claim 19, wherein at least one or more of the four phase modulators comprises a delay-locked loop, an open loop delay line, a closed loop delay line and a delay-locked loop, a delay-locked loop controlled by a digital-to-analog converter, a delay line with sigma-delta phase selection in open loop, or a delay line with sigma-delta phase selection in open loop embedded in a delay-locked loop, a phase-locked loop, an integer-n phase-locked loop, a fractional-n phase-locked loop, an offset loop phase-locked loop, a reference modulated phase-locked loop, or a direct digital synthesis circuit, or combinations thereof.

23. An apparatus as claimed in claim 19, wherein the four phase modulators operate at a lower bandwidth than phase modulation involving fewer than four modulation paths at a higher bandwidth.

24. An apparatus as claimed in claim 19, wherein a frequency spectrum of the pulse position and pulse width modulated signal to be transmitted exhibits greater out of band attenuation than phase modulation involving fewer than four modulation paths.

25. An apparatus as claimed in claim 19, further comprising one or more switching power amplifiers to amplify the pulse position and pulse width modulated signal to be transmitted to a power level suitable for transmission.

26. An apparatus as claimed in claim 19, wherein the pulse position and pulse width modulated signal to be transmitted provided by the combiner comprises a differential signal.

27. An apparatus as claimed in claim 19, wherein the combiner comprises a pulse-width modulation combiner.

28. An apparatus as claimed in claim 19, wherein the combiner comprises one or more logic gates and one or more digital-to-analog converters.
